(19) United States
(12) Patent Application Publication
(10) Pub. No.: US 2024/0393629 A1
(43) Pub. Date: Nov. 28, 2024

(54) DISPLAY APPARATUS AND METHOD OF MANUFACTURING THE SAME

(71) Applicant: Japan Display Inc., Tokyo (JP)

(72) Inventor: Youhei IWAI, Tokyo (JP)

(21) Appl. No.: 18/670,774

(22) Filed: May 22, 2024

(30) Foreign Application Priority Data
May 26, 2023 (JP) 2023-087204

(51) Int. Cl. G02F 1/1333

(52) U.S. Cl. CPC G02F 1/133311; G02F 2201/50; G02F 2202/28

(57) ABSTRACT

In a display apparatus in which a liquid crystal panel is arranged on a protective plate curved to have a large curvature at an end, color unevenness of displayed images is suppressed. The display apparatus includes: a light-transmitting protective plate; a light-transmitting adhesive layer arranged on a rear surface of the protective plate; and a liquid crystal panel adhered to the protective plate through the light-transmitting adhesive layer. The protective plate is formed such that an end is curved to have a larger curvature than a curvature of a center and such that the end includes a region where a curvature of a rear surface is smaller than a curvature of a front surface. The liquid crystal panel is arranged to continuously cover at least a part of the center and the region of the end in the protective plate.

### CROSS-REFERENCE TO RELATED APPLICATION

The present application claims priority to Japanese Patent Application No. 2023-087204 filed on May 26, 2023, the disclosure of which is incorporated herein by reference.

### TECHNICAL FIELD OF THE INVENTION

The present invention relates to a display apparatus and a method of manufacturing the same.

### BACKGROUND OF THE INVENTION

A display apparatus in which a liquid crystal panel is arranged on a light-transmitting protective plate has been known. Japanese Patent Application Laid-open Publication No. 2016-66085 (Patent Document 1) describes a display apparatus, which includes a protective plate having a plurality of parts, facing directions of which are different from one another because the parts have a plurality of bends to be bent, and in which a plurality of display units are adhered to respective rear surfaces of the plurality of parts of the protective plate by a light-transmitting adhesive layer.

### SUMMARY OF THE INVENTION

In recent years, there is the increasing need for display apparatuses in each of which a liquid crystal panel is arranged on a rear surface of a protective plate curved to have an end which is larger in curvature than a center. In this specification, A phrase “large curvature” is used synonymously with “small curvature radius”, and means relatively steep curving. A phrase “small curvature” is used synonymously with “large curvature radius”, and means relatively gentle curving.

However, a liquid crystal panel generally includes a glass substrate, and has relatively high hardness. Thus, the liquid crystal panel tends to be distorted when being arranged along the liquid crystal panel and the curved protective plate, and color unevenness of images displayed on a panel surface that is a display surface of the display apparatus tends to be caused.

Because of such circumstances, there is the demand to develop a technique capable of suppressing the color unevenness of the displayed images in the display apparatus in which the liquid crystal panel is arranged on the protective plate curved to have the large curvature at the end.

According to one embodiment, a display apparatus includes: a light-transmitting protective plate; a light-transmitting adhesive layer arranged on a rear surface of the protective plate; and a liquid crystal panel arranged on a rear surface of the light-transmitting adhesive layer. The protective plate has a center and an end, and is curved such that the end has a larger curvature than that of the center, a rear surface of the end includes a curved surface having a smaller curvature than a curvature of a front surface of the end, and the liquid crystal panel is arranged to continuously cover a rear surface of the center and the curved surface of the rear surface of the end in the protective plate.

According to one embodiment, in a method of manufacturing a display apparatus including: a light-transmitting protective plate; a light-transmitting adhesive layer arranged on a rear surface of the protective plate; and a liquid crystal panel arranged on a rear surface of the light-transmitting adhesive layer, the method includes: a step of shaping the protective plate by pressing a melted glass material or resin material under use of a mold such that the protective plate is curved to have a larger curvature at an end than a center and such that a rear surface of the end includes a curved surface having a smaller curvature than a curvature of a front surface of the end; a step of applying a light-transmitting adhesive on at least either one of the rear surface of the protective plate and a front surface of the liquid crystal panel; and a step of compressively adhering the protective plate and the liquid crystal panel such that the liquid crystal panel continuously covers a rear surface of the center and the curved surface of the rear surface of the end in the protective plate.

### BRIEF DESCRIPTIONS OF THE DRAWINGS

FIG. 1 is a rear-surface view of a display apparatus according to a first embodiment.

FIG. 2 is a cross-sectional view of the display apparatus according to the first embodiment.

FIG. 3 is an enlarged cross-sectional view of a principal part of the display apparatus according to the first embodiment.

FIG. 4 is a flowchart showing an example of a method of manufacturing the display apparatus according to the first embodiment.

FIG. 5 is a diagram showing a method of shaping a protective plate by a pressing process, according to the first embodiment.

FIG. 6 is an enlarged cross-sectional view of a principal part of a display apparatus according to a second embodiment.

FIG. 7 is a diagram showing an exemplary configuration of a display apparatus according to a first modification example of the first and second embodiments.

FIG. 8 is a diagram showing an exemplary configuration of a display apparatus according to a second modification example of the first and second embodiments.

### DESCRIPTIONS OF THE PREFERRED EMBODIMENTS

### Background of Study made by Present Inventors

The background of the study made by the present inventors will be explained prior to explanations for embodiments.

The present inventors have paid attention to display apparatuses in each of which a liquid crystal panel is adhered to a rear surface of a curved light-transmitting protective plate via a light-transmitting adhesive.

Such a display apparatus is used when it is attempted to, for example, provide an information display function to a curved portion of a structure having a curved surface in terms of design or functionality. In recent years, there is the increasing need for such display apparatuses in each of which a liquid crystal panel is adhered to a curved protective plate.

Meanwhile, a glass substrate is generally used for a liquid crystal panel, and the liquid crystal panel has relatively high hardness. Thus, if the liquid crystal panel is tightly adhered to the rear surface of the curved protective plate, relatively large shear stress is caused at a part having a large curvature in the protective plate of the liquid crystal panel. If the shear stress is caused in the liquid crystal panel, a distance between a pair of facing glass substrates in the liquid crystal panel is ununiform, and light transmittance of each pixel of a light emission surface that is the front surface of the liquid crystal panel is also ununiform. That is, the color unevenness of the images displayed on the liquid crystal panel tends to be caused.

A form of the protective plate is various. However, for achieving both the design and the functionality, particularly, the center is made of a flat surface or a curved surface having a small curvature while the end is made of a curved surface having a larger curvature often. In such a case, in the liquid crystal panel adhered to the rear surface of the protective plate, the large shear stress is caused particularly at the end, and the color unevenness of the displayed images tends to be caused.

The present inventors have studied in consideration of the above-described circumstances, and have found a technique capable of suppressing the color unevenness on the display surface in the display apparatus in which the liquid crystal panel is arranged on the protective plate curved to have the large curvature at the end. The embodiments of the technique will be explained.

In order to prevent the large shear stress on the liquid crystal panel, a method of arranging a plurality of liquid crystal panels side by side on the rear surface of the curved protective plate is considerable. However, by this method, the display surface of the display apparatus is divided between adjacent liquid crystal panels. Further, this method needs to accurately adhere the plurality of liquid crystal panels to the protective plate, and thus, time and steps for the manufacture increase, and a manufacture cost also increases. The embodiments of the technique disclosed in this specification can also solve such problems.

The embodiments will be explained below. The following explained embodiments relate to a display apparatus including: a light-transmitting protective plate; a light-transmitting adhesive layer arranged on a rear surface of the protective plate; and a liquid crystal panel arranged on a rear surface of the light-transmitting adhesive layer. The protective plate has a center and an end, and is curved such that the end has a larger curvature that is a smaller curvature radius than that of the center, a rear surface of the end includes a curved surface having a smaller curvature that is a larger curvature radius than a curvature of a front surface of the end. The liquid crystal panel is arranged to continuously cover a rear surface of the center and the curved surface of the rear surface of the end in the protective plate.

### First Embodiment

A first embodiment is an example of a display apparatus in which a rear surface of an end of a protective plate is a surface not concaved but extended from a rear surface of a center of the protective plate, and includes a curved surface having a smaller curvature than a curvature of a front surface of the end of the protective plate.

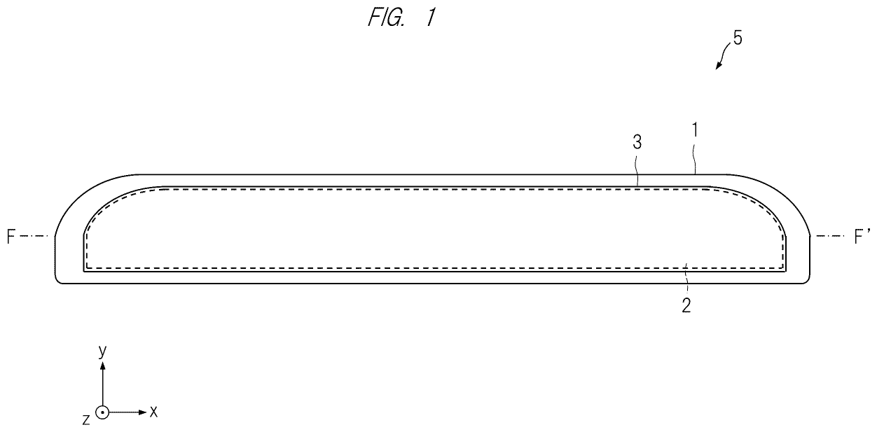

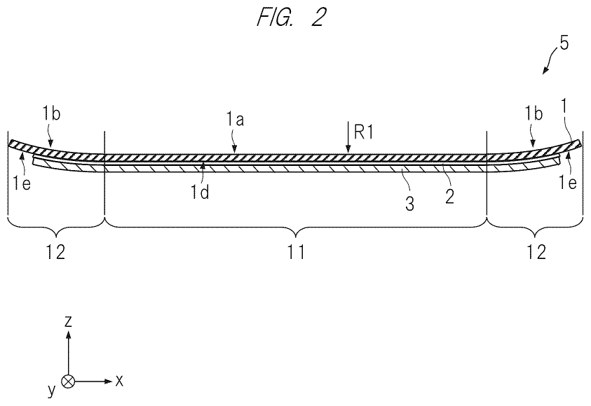

FIG. 1 is a rear-surface view of the display apparatus according to the first embodiment. FIG. 2 is a cross-sectional view of the display apparatus according to the first embodiment. FIG. 2 corresponds to a cross-section F-F′ of FIG. 1. Note that the front surface described here means a surface close to a viewer when the viewer views the display surface of the display apparatus, and the rear surface means a surface opposite to the front surface. That is, when it is assumed that a direction of a line of sight of the viewer is a direction R1, a side beyond an opposite direction to the direction R1 is referred to as the front surface. A direction travelling from the rear surface to the front surface of the display apparatus 5 according to the first embodiment is assumed as y direction, a direction travelling from the left to the right of the rear surface of the display apparatus 5 is assumed as x direction, and a direction travelling from the bottom to the top of the rear surface of the display apparatus 5 is assumed as z direction.

As shown in FIG. 1, the display apparatus 5 according to the first embodiment includes: a light-transmitting protective plate 1; a light-transmitting adhesive layer 2 arranged on a rear surface of the protective plate 1; and a liquid crystal panel 3 arranged on a rear surface of the light-transmitting adhesive layer 2. The protective plate 1 is, for example, a light-transmitting cover glass. The liquid crystal panel 3 has a well-known configuration including two light-transmitting glass substrates and liquid crystal sandwiched between the glass substrates. The liquid crystal panel 3 generally includes a light-transmitting electrode, a polarization plate and the like, and is connected to a flexible circuit board. However, these components are less relevant to the technique disclosed in this application, and thus, are neither illustrated nor explained herein.

The protective plate 1 includes a center 11 and an end 12. The end 12 is curved to have a larger curvature than that of the center 11. The center 11 and the end 12 are unified.

A surface shape of the protective plate 1, in other words, a shape of the same viewed from the rear surface, is a shape different from a quadrangular shape. In the example of FIG. 1, the surface shape of the protective plate 1 is a shape achieved by changing corners of a quadrangular shape into smooth curves. Two curved shapes of the protective plate 1 close to a positive side of the y direction are curved shapes having a relatively small curvature. Two curved shapes of the protective plate 1 close to a negative side of the y direction are curved shapes having a relatively large curvature.

As shown in FIG. 2, the protective plate 1 includes the center 11 and the two ends 12 on both sides of the center 11 in the x direction. The center 11 described here has a flat-plate shape, and a thickness of the center 11 is constant. That is, a front surface 1a and a rear surface 1d of the center 11 are flat surfaces perpendicular in the z direction. Note that the center 11 may have a curved-plate shape to be gently curved on a positive side of the z direction.

Each of the two ends 12 on both sides of the protective plate 1 has a curved-plate shape in which a front surface 1b is curved on the positive side of the z direction. The shape of the end 12 will be described in detail below.

As shown in FIG. 1, the liquid crystal panel 3 has a size smaller than the protective plate 1 to be within the rear surface region of the protective plate 1. A surface shape of the liquid crystal panel 3, that is a shape of the liquid crystal panel 3 viewed from the rear surface, is a shape different from a quadrangular shape. The shape of the liquid crystal panel 3 is close to a downsized contour of the rear surface of the protective plate 1. That is, the surface shape of the liquid crystal panel 3 is close to an entirely downsized surface shape of the protective plate 1.

A principal part of the liquid crystal panel 3 includes a pair of glass substrates arranged to face each other, and liquid crystal sandwiched between the glass substrates. The glass substrate generally has a flat-plate shape and a relatively high hardness as a material property. Thus, the liquid crystal panel 3 generally has a flat-plate shape as a whole. However, the rear surface 1e of the end 12 of the protective plate 1 is curved. Thus, a part of the liquid crystal panel 3, the part being adhered to the rear surface 1e of the end 12 of the protective plate 1, is adhered while being curved along the curved rear surface 1e of the end 12. By this curved shape, the shear stress is caused on the curved part of the liquid crystal panel 3.

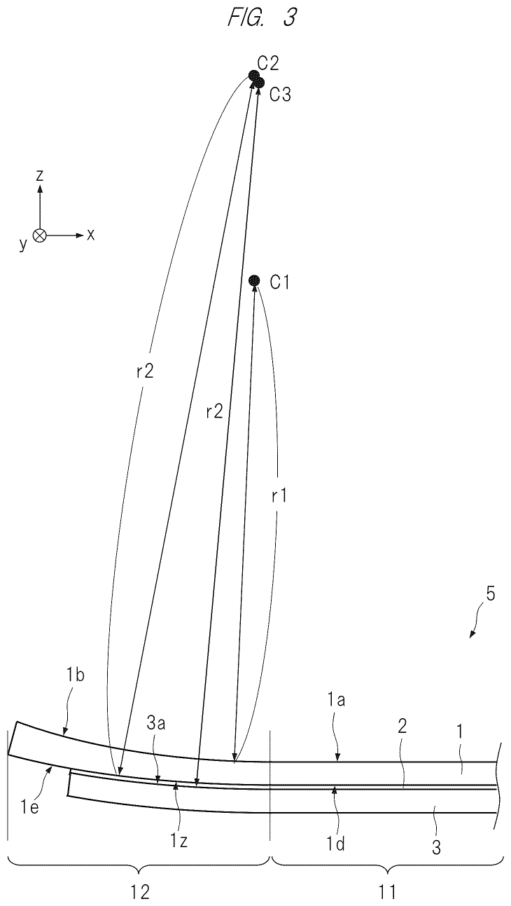

FIG. 3 is an enlarged cross-sectional view of the principal part of the display apparatus according to the first embodiment. FIG. 3 shows one end of the display apparatus 5 in the x direction and its peripheral part.

As shown in FIG. 3, the protective plate 1 is formed such that its end 12 is curved to have a larger curvature than that of the center 11 while the rear surface 1e of the end 12 includes a curved surface 1z having a smaller curvature than a curvature of the front surface 1b of the end 12. The protective plate 1 is formed such that a surface not concaved but extended from the rear surface 1d of the center 11 includes the curved surface 1z. The liquid crystal panel 3 is arranged to continuously cover the rear surface 1d of the center 11 and the curved surfaces 1z of the rear surfaces 1e of the ends 12 in the protective plate 1.

The end 12 of the protective plate 1 is curved to be warped toward the positive side of the y direction. However, the front surface 1b of the end 12 and the curved surface 1z of the rear surface 1e of the end 12 are different from each other in curvature. A curvature center C1 of the front surface 1b is close to the front surface 1b of the protective plate 1, and a curvature radius of the front surface 1b is “r1”. To the contrary, a curvature center C2 of the curved surface 1z of the rear surface 1e is close to the front surface 1b of the protective plate 1, and a curvature radius of the rear surface 1e is “r2” larger than r1. That is, a curvature of a front surface 3a of the liquid crystal panel 3, the front surface being adhered to the curved surface 1z of the rear surface 1e of the end 12 in the protective plate 1, is smaller than a curvature of the front surface 1b of the end 12, and the curve of the curved surface 1z is gentler than that of the front surface 1b.

Since the protective plate 1 is formed to have the above-described shape, the liquid crystal panel 3 at the end 12 is also adhered along the curved surface 1z that is relatively gently curved. The light-transmitting adhesive layer 2 is formed such that its thickness is substantially uniform. In this case, the front surface 3a at the end 12 of the liquid crystal panel 3 has a curvature center C3 close to the curvature center C2 as similar to the curved surface 1z, and is curved at a curvature to have the curvature radius r2 larger than the curvature radius r1.

Thus, the shear stress caused on the part of the liquid crystal panel 3, the part being adhered to the end 12 of the protective plate 1, is smaller than that of a part adhered to the curved surface having the same curvature as that of the front surface 1b. By the small shear stress of the liquid crystal panel 3, the ununiformity of the distance between the glass substrates of the liquid crystal panel 3 is reduced, and the color unevenness of the images displayed on the liquid crystal panel 3 is suppressed.

In the first embodiment, note that the front surface 1b and the curved surface 1z of the rear surface 1e in the end 12 are different in curvature from each other in order to make the curvature of the surface of the liquid crystal panel 3, the surface being adhered to the curved surface 1z of the end 12 of the protective plate 1, smaller than the curvature of the front surface 1b of the end 12. This case provides excellent workability of the adhering step as different from the case of the designed change of the thickness of the light-transmitting adhesive layer 2 in the x direction, and the curvature of the liquid crystal panel 3 can be stably adjusted.

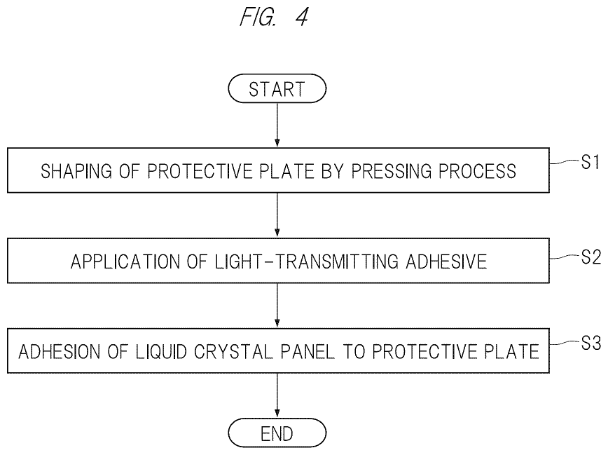

A method of manufacturing the display apparatus 5 will be described herein. FIG. 4 is a flowchart showing an example of a method of manufacturing the display apparatus according to the first embodiment.

As shown in FIG. 4, in step S1, the protective plate is shaped by the pressing process. The protective plate 1 according to the first embodiment is different from a typical protective plate having a constant thickness in that the curvature of the front surface 1b of the end 12 is different from the curvature of the curved surface 1z of the rear surface 1e such that the thickness of the end 12 smoothly changes in the x direction. Thus, the protective plate 1 is not easily shaped by a typical bending process. Therefore, the protective plate 1 is preferably shaped by the pressing process. A method of shaping the protective plate 1 by the pressing process will be explained below.

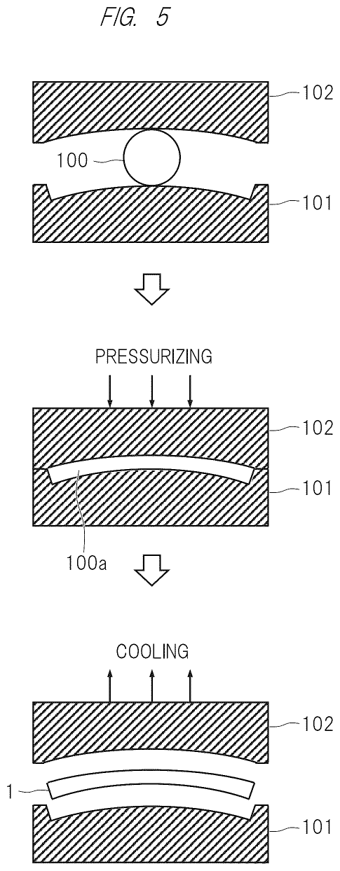

FIG. 5 is a diagram showing the method of shaping the protective plate by the pressing process, according to the first embodiment. As shown in FIG. 5, a lower mold 101 and an upper mold 102 fitting with the shape of the protective plate 1 are prepared first. Next, a glass material 100 melted by heating is loaded between the lower mold 101 and the upper mold 102.

Alternatively, the glass material 100 is loaded between the lower mold 101 and the upper mold 102, and then, is heated and melted by heat conduction from the molds.

Next, the upper mold 102 is pressed relatively down against the lower mold 101 to pressurize the glass material 100. The glass material 100 is shaped to fit with the shapes of the molds by the pressurization using the molds to provide a shaped glass material 100a.

Then, thermal exchange is generated between the shaped glass material 100a and the molds, and the shaped glass material 100a is cooled. By this cooling, the shaped glass material 100a is solidified to be the shaped protective plate 1.

If the protective plate 1 needs to be made of resin, a resin material is used instead of the glass material 100.

Return to FIG. 4, and the explanation will be continued. In step S2, a light-transmitting adhesive is applied. Specifically, the light-transmitting adhesive is applied to form an appropriate thickness on the rear surface of the protective plate 1 or the front surface of the liquid crystal panel 3.

In step S3, the liquid crystal panel is adhered to the protective plate. Specifically, the liquid crystal panel 3 is adhered to the protective plate 1 through the light-transmitting adhesive layer 2. The light-transmitting adhesive is hardened by, for example, irradiation of visible light ray or ultraviolet ray, heating, drying, and the like.

According to the first embodiment, the protective plate 1 is formed such that the curvature of the curved surface 1z of the rear surface 1e of the end 12 in the protective plate 1 is smaller than the curvature of the front surface 1b of the end 12. Thus, when the liquid crystal panel 3 is adhered to the rear surface of the protective plate 1 where the curvature of the end 12 in the protective plate 1 is larger than the curvature of the center 11, the curvature of the front surface 3a of the liquid crystal panel, the front surface being adhered to the rear surface 1e of the end 12, can be reduced. Consequently, shear stress caused at the end of the liquid crystal panel 3 by the adhesion of this curved end can be reduced, and the color unevenness of the images displayed on the liquid crystal panel 3 can be suppressed.

That is, according to the first embodiment, the color unevenness of the displayed images can be suppressed in the display apparatus in which the liquid crystal panel is arranged on the protective plate, the end of which is curved to have the larger curvature.

Note that it has been found that the color unevenness of the images displayed on the liquid crystal panel 3 tends to be more remarkable in the case in which the surface shape of the 1 liquid crystal panel 3 is the shape different from the quadrangular shape than the case in which the surface shape of the liquid crystal panel 3 is the quadrangular shape. The case in which the surface shape of the liquid crystal panel 3 is the shape different from the quadrangular shape means a case in which the surface shape of the liquid crystal panel 3 is a shape achieved by, for example, shaping corners of the quadrangular surface shape of the liquid crystal panel 3 to be curved or more corners. Thus, an effect of suppressing the color unevenness of the images displayed on the liquid crystal panel 3 is larger particularly in the case in which the surface shape of the liquid crystal panel 3 is the shape different from the quadrangular shape.

### Second Embodiment

A second embodiment is an example of a display apparatus in which a protective plate is formed such that a rear surface of a curved end has a concave while a bottom of the concave includes a curved surface having a smaller curvature than a curvature of a front surface of the end.

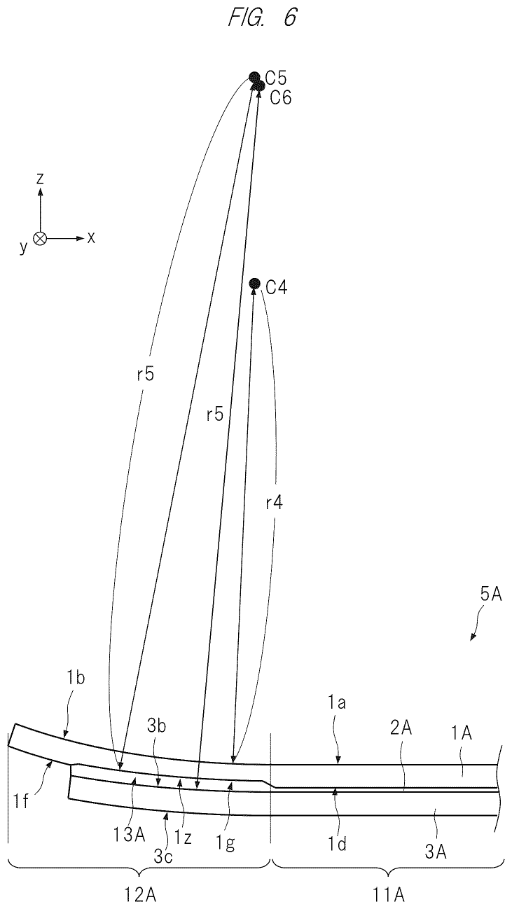

FIG. 6 is an enlarged cross-sectional view of a principal part of the display apparatus according to the second embodiment. FIG. 6 shows one end of a display apparatus 5A in the x direction and its peripheral part.

As similar to the first embodiment, the display apparatus 5A according to the second embodiment includes a protective plate 1A, a light-transmitting adhesive layer 2A, and a liquid crystal panel 3A. The light-transmitting adhesive layer 2A is arranged on a rear surface of the protective plate 1A, that is a surface of the same close to a negative side of the z direction. The liquid crystal panel 3A is arranged on a rear surface of the light-transmitting adhesive layer 2A, that is a surface of the same close to the negative side of the z direction, and is adhered to the rear surface of the protective plate 1A by the light- transmitting adhesive layer 2A.

As shown in FIG. 6, the protective plate 1A is made of a center 11A and an end 12A. The center 11A described here has a flat-plate shape, and a thickness of the center 11A is constant.

As shown in FIG. 6, the protective plate 1A is formed such that the end 12A has a concave 13A on its rear surface lf while a bottom 1g of the concave 13A includes a curved surface 1z having a smaller curvature than a curvature of a front surface 1b of the end 12A.

More specifically, the end 12A of the protective plate 1A is curved to protrude toward the positive side of the z direction. The front surface 1b of the end 12A has a curvature center C4 close to the protective plate 1A side, and is curved at a curvature radius r4. To the contrary, the rear surface lf of the end 12A has the concave 13A concaved toward the front surface 1b side, in other words, toward the positive side of the z direction. The bottom 1g of the concave 13A of the end 12A has a curvature center C5 close to the positive side of the y direction, and is curved at a curvature radius r5 larger than the curvature radius r4. That is, the curvature of the bottom 1g of the concave 13A formed on the rear surface 1f of the end 12A in the protective plate 1A is smaller than the curvature of the front surface 1b of the end 12A of the protective plate 1A, and its curving is gentler than that of the front surface 1b.

The light-transmitting adhesive layer 2A is arranged between the protective plate 1A and the liquid crystal panel 3A. The light-transmitting adhesive layer 2A is formed by applying the light-transmitting adhesive onto the rear surface of the protective plate 1A or the front surface of the liquid crystal panel 3A, and compressively adhering the protective plate 1A and the liquid crystal panel 3A. At the time of the compressive adhesion between the protective plate 1A and the liquid crystal panel 3A, a part of the light-transmitting adhesive applied on the rear surface of the protective plate 1A or the front surface of the liquid crystal panel 3A enters the concave 13A. Then, a front surface 3b of the liquid crystal panel 3A is curved at substantially the same or approximate curvature as or to that of the bottom 1g of the concave 13A by a pressure relatively applied from a rear surface 3c of the liquid crystal panel 3A and a reaction force applied from the light-transmitting adhesive entering the concave 13A.

Since the protective plate 1A is formed such that the rear surface lf of the end 12A has the concave 13A, the liquid crystal panel 3A is adhered along the curved surface having substantially the same curvature as that of the curved surface of the relatively gently curved bottom 1g even at the end 12A. The thickness of the light-transmitting adhesive layer 2A changes to substantially absorb the dent of the concave 13A. In this case, the front surface 3b of the end 12A of the liquid crystal panel 3A has a curvature center C6 close to the curvature center C5 as similar to the bottom 1g, and is curved at the curvature to have the curvature radius r5 larger than the curvature radius r4.

Therefore, shear stress caused on the part of the liquid crystal panel 3A, the part being adhered to the end 12A of the protective plate 1, is smaller than shear stress caused on a part adhered to the curved surface having the same curvature as that of the front surface 1b. By the small shear stress on the liquid crystal panel 3A, the ununiformity of the distance between the glass substrates of the liquid crystal panel 3A is reduced, and the color unevenness of the images displayed on the liquid crystal panel 3A is suppressed.

That is, according to the second embodiment, as similar to the first embodiment, the color unevenness of the displayed images can be suppressed in the display apparatus in which the liquid crystal panel is arranged on the protective plate having the end curved to have a larger curvature.

### Modification Examples of First and Second Embodiments

### First Modification Example

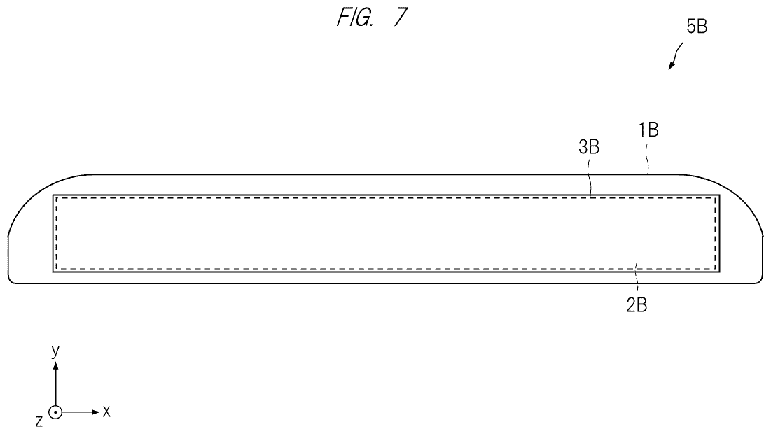

FIG. 7 is a diagram showing an exemplary configuration of a display apparatus according to a first modification example of the first and second embodiments. As shown in FIG. 7, a display apparatus 5B according to the first modification example of the first and second embodiments includes a protective plate 1B, a light-transmitting adhesive layer 2B, and a liquid crystal panel 3B. The light-transmitting adhesive layer 2B is arranged between the protective plate 1B and the liquid crystal panel 3B.

In the display apparatus 5B according to the first modification example, a surface shape of the protective plate 1B is a shape different from a quadrangular shape while a surface shape of the liquid crystal panel 3B is a quadrangular shape. The first and second embodiments are also applicable to a combination of the protective plate 1B and the liquid crystal panel 3B having such shapes.

In the example of FIG. 7, the surface shape of the protective plate 1B is a shape achieved by changing corners of a rectangular shape into curves. To the contrary, the surface shape of the liquid crystal panel 3B is the rectangular shape. The light-transmitting adhesive layer 2B has a substantially similar surface shape to that of the liquid crystal panel 3B. Note that the surface shape of the protective plate 1B may be a polygonal shape achieved by changing corners of a quadrangular shape into more corners. Other components and configurations of the protective plate 1B and the liquid crystal panel 3B are similar to those of the first or second embodiment.

In the display apparatus 5B according to the first modification example as described above, as similar to the first and second embodiments, the curvature of the part adhered to the end of the liquid crystal panel 3B can be made smaller than the curvature of the curved end of the protective plate 1B. Consequently, shear stress caused at the end of the liquid crystal panel 3B can be reduced, and the color unevenness of the images displayed on the liquid crystal panel 3B can be suppressed.

### Second Modification Example

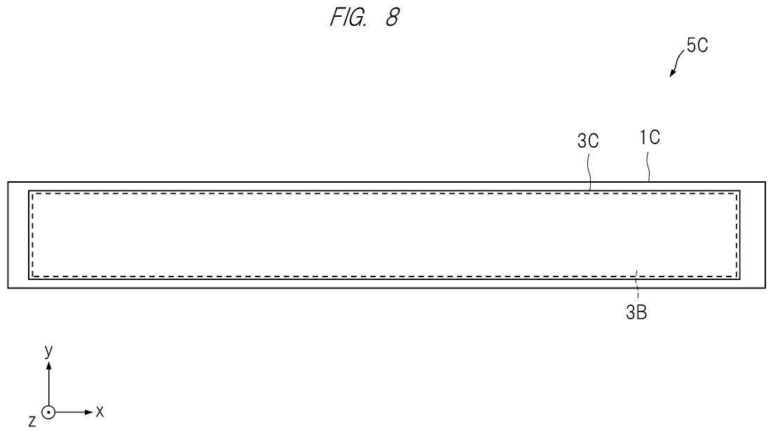

FIG. 8 is a diagram showing an exemplary configuration of a display apparatus according to a second modification example of the first and second embodiments. As shown in FIG. 8, a display apparatus 5C according to the second modification example of the first and second embodiments includes a protective plate 1C, a light-transmitting adhesive layer 2C, and a liquid crystal panel 3C. The light-transmitting adhesive layer 2C is arranged between the protective plate 1C and the liquid crystal panel 3C.

In the display apparatus 5C according to the second modification example, a surface shape of the protective plate 1C is a rectangular shape while a surface shape of the liquid crystal panel 3C is a rectangular shape. The first and second embodiments are also applicable to a combination of the protective plate 1C and the liquid crystal panel 3C having such shapes.

In the example of FIG. 8, the surface shape of the protective plate 1C is a rectangular shape. Meanwhile, the surface shape of the liquid crystal panel 3C is also a rectangular shape. The light-transmitting a adhesive layer 2C has substantially similar surface shape to that of the liquid crystal panel 3C. Note that the surface shape of the liquid crystal panel 3C may be a polygonal shape achieved by changing corners of a quadrangular shape into more corners. Other components and configurations of the protective plate 1C and the liquid crystal panel 3C are similar to those of the first or second embodiment.

In the display apparatus 5B according to the first modification example as described above, as similar to the first and second embodiments, the curvature of the part adhered to the end of the liquid crystal panel 3C can be made smaller than the curvature of the curved end of the protective plate 1C. Consequently, shear stress caused at the end of the liquid crystal panel 3C can be reduced, and the color unevenness of the images displayed on the liquid crystal panel 3C can be suppressed.

### Third Modification Example

A display apparatus according to a third modification example is an example in which the surface shape of the protective plate is a shape adapted to at least a part of any of a windshield glass, a rear-view mirror, an instrument panel, a console and a window of a vehicle. The vehicle may be, for example, a motorcar, a motorcycle, a train, a monorail car, an airplane, a balloon, a ship, a submarine or the like. The display apparatus according to the third modification example is an example in which the surface shape of the protective plate is a shape adapted to at least a part of a display portion of a transportation means such as an elevator or an escalator or a display portion of an electronic product.

Particularly, in order to meet both design and functionality in the windshield glass, the rear-view mirror, the instrument panel, the console, or the window of the vehicle, a display apparatus including a light-transmitting protective plate having a curved end and a liquid crystal panel adhered to its rear surface is often used. Thus, achievement of the display apparatus according to the third modification example has been eagerly desired, and the effects of the first and second embodiments based on the third modification example are valuable.

Various embodiments and various modification examples of the present invention have been described above. However, the present invention is not limited to the above-described embodiments, and includes various modification examples. The above-described embodiments have been described in detail for easily understanding the explanation for the present invention, and are not always limited to the ones including all the explained components. Also, a part of the structure of one embodiment can be replaced with the structure of another embodiment, and besides, the structure of another embodiment can be added to the structure of one embodiment. All the modification examples belong to the cope of the present invention. Further, numerical values and the like in the present specification and the drawings are only example values, and the effects of the present invention are not lost by use of different values.

What is claimed is:

1. A display apparatus comprising:
a light-transmitting protective plate;
a light-transmitting adhesive layer arranged on a rear surface of the protective plate; and
a liquid crystal panel arranged on a rear surface of the light-transmitting adhesive layer,
wherein the protective plate has a center and an end, and is curved such that the end has a larger curvature than a curvature of the center, and a rear surface of the end includes a curved surface having a smaller curvature than a curvature of a front surface of the end, and
the liquid crystal panel is arranged to continuously cover a rear surface of the center and the curved surface of the rear surface of the end in the protective plate.

2. The display apparatus according to claim 1,
wherein the rear surface of the end is a surface not concaved but extended from the rear surface of the center, and
the surface includes the curved surface.

3. The display apparatus according to claim 1,
wherein the rear surface of the end has a concave, and
a bottom of the concave includes the curved surface.

4. The display apparatus according to claim 1,
wherein a surface shape of the protective plate is a shape different from a quadrangular shape, and
a surface shape of the liquid crystal panel is a shape different from a quadrangular shape.

5. The display apparatus according to claim 1,
wherein a surface shape of the protective plate is a shape different from a quadrangular shape, and
a surface shape of the liquid crystal panel is a quadrangular shape.

6. The display apparatus according to claim 1,
wherein a surface shape of the protective plate is a quadrangular shape, and
a surface shape of the liquid crystal panel is a quadrangular shape.

7. The display apparatus according to claim 4,
wherein a surface shape of the protective plate is a shape adapted to at least a part of any of a windshield glass, a rear-view mirror, an instrument panel, a console, and a window of a vehicle.

8. A method of manufacturing a display apparatus including a light-transmitting protective plate, a light-transmitting adhesive layer arranged on a rear surface of the protective plate, and a liquid crystal panel arranged on a rear surface of the light-transmitting adhesive layer, the method comprising steps of:
shaping the protective plate by pressing a melted glass material or resin material under use of a mold such that the protective plate is curved to have a larger curvature at an end than a center and such that a rear surface of the end includes a curved surface having a smaller curvature than a curvature of a front surface of the end;
applying a light-transmitting adhesive onto at least either one of the rear surface of the protective plate and a front surface of the liquid crystal panel; and
compressively adhering the protective plate and the liquid crystal panel such that the liquid crystal panel continuously covers a rear surface of the center and the curved surface of the rear surface of the end in the protective plate.
